(19) United States
(12) Patent Application Publication
(10) Pub. No.: US 2019/0024814 A1
(43) Pub. Date: Jan. 24, 2019

(54) CHECK VALVE FOR A VARIABLE COMPRESSION INTERNAL COMBUSTION ENGINE AND A CONNECTING ROD WITH THE CHECK VALVE

(71) Applicant: ECO HOLDING 1 GMBH, Marktheidenfeld (DE)

(72) Inventors: ALEXANDER MUDRA, Marktheidenfeld (DE); DIETMAR SCHULZE, Muenzenberg (DE)

(21) Appl. No.: 16/135,876

(22) Filed: Sep. 19, 2018

Related U.S. Application Data
(63) Continuation of application No. PCT/EP2017/055251, filed on Mar. 2, 2017.

(30) Foreign Application Priority Data
Mar. 21, 2016 (DE) 102016105220.5
Aug. 12, 2016 (DE) 102016114976.4

(51) Int. Cl. F16K 27/02; F16K 15/06; F02B 75/04; F16C 7/06; F16C 23/10

(52) U.S. Cl. CPC F16K 27/0209; F16K 15/063; F02B 75/045; F16C 2361/91; F16C 23/10; F16C 2360/22; F16C 7/06

(57) ABSTRACT

A check valve for a connecting rod with at least one hydraulic chamber for a variable compression internal combustion engine, wherein the hydraulic chamber is connectable by the check valve with a hydraulic fluid conduit, and wherein the check valve includes a valve closure element that is configured as a disc.

### RELATED APPLICATIONS

This application is a continuation of international application PCT/EP 2017 055 251 filed on Mar. 7, 2017, claiming priority from German patent applications
DE 10 2016 105 220.5 filed on Mar. 21, 2016, and
DE 10 2016 114 976,4 filed on Aug. 12 2016.

### FIELD OF THE INVENTION

The invention relates to a check valve for a variable compression internal combustion engine and a connecting rod with the check valve.

### BACKGROUND OF THE INVENTION

In internal combustion engines a high compression ratio has a positive effect upon an efficiency of the internal combustion engine. Compression ratio is typically defined as a ratio of an entire cylinder cavity before compression to a remaining cylinder cavity after compression. In internal combustion engines with external ignition, in particular gasoline engines that have a fixed compression ratio, the compression ratio, however, may only be selected high enough so that a so-called “knocking” of the internal combustion engine is prevented during full load operations. However, for much more prevalent partial load operations of the internal combustion engine, thus for a lower cylinder charge the compression ratio can be selected at a higher level without “knocking” occurring. The important partial load operations of an internal combustion engine can be improved when the compression ratio is variably adjustable. In order to adjust the compression ratio systems with variable connecting rod links are known which actuate an eccentrical adjustment arrangement of a connecting rod by hydraulically or mechanically actuatable switch valves.

A generic connecting rod of this type is known for example DE 10 2012 112 461 A1 and includes an eccentrical element adjustment arrangement for adjusting an effective connecting rod length wherein the eccentrical element adjustment arrangement includes an eccentrical element that cooperates with an eccentrical element lever and two pistons which are respectively movably supported in a hydraulic chamber and at which eccentrical element rods of the eccentrical element adjustment arrangement that engage the eccentrical element lever are supported. An adjustment travel of the eccentrical element adjustment arrangement is adjustable by a switch valve. Changing the adjustment travel changes an effective connecting rod length. Thus, a compression of the internal combustion engine can be controlled. Check valves in the connecting rod respectively prevent a flowback of hydraulic fluid from the hydraulic chamber into a bearing shell or a tank.

### BRIEF SUMMARY OF THE INVENTION

Thus, it is an object of the invention to provide an improved check valve with a long service life and an improved connecting rod with the check valve.

The object is achieved according to the invention by a check valve for a connecting rod with at least one hydraulic chamber for a variable compression internal combustion engine, wherein the hydraulic chamber is connectable by the check valve with a hydraulic fluid conduit, and wherein the check valve includes a valve closure element that is configured as a disc.

Advantageous embodiments and advantages of the invention can be derived from the dependent claims, the description and the drawing figure.

A check valve is proposed for a connecting rod for a variable compression internal combustion engine with at least one hydraulic chamber in the connecting rod, wherein the hydraulic chamber is connectable by the check valve with a hydraulic fluid conduit.

According to the invention the check valve includes a disk that is configured as a valve closure element.

In the check valve according to the invention with the valve closure element configured as a disk, the valve closure element is arranged in flow direction with the valve open downstream of a valve spring that presses the valve closure element into the valve seat. Thus, it is possible with this design principle to arrange the valve spring in a low pressure portion of the hydraulic fluid so that the function of the valve spring cannot be influenced by hydraulic fluid in the high pressure portion. This arrangement also facilitates supporting an entire length of the valve spring by a contact sleeve of the check valve so that a reliable function of the check valve is also assured under vibrations or jolts. This improves durability of the valve spring, in particular when the valve spring is used in a hydraulic chamber of a connecting rod for a variable compression internal combustion engine.

Advantageously the check valve provides a stable support for the valve spring and thus reliable switching properties for the check valve. The valve spring in the check valve according to the invention is not directly exposed to the hydraulic fluid flow and to possible pressure spikes in the hydraulic chamber.

Since a surface area of the disk forming the valve closure element is greater than a surface area of a comparable ball, higher forces are imparted upon the valve closure element by the same hydraulic fluid pressure which facilitates using more robust and stronger valve springs which in turn provides stiffer dynamic properties of the check valve. For the same flow cross-section the valve closure element configured as a disk has to perform a smaller stroke than a valve closure element that is configured as a sphere while still providing a large opening cross-section. Thus, the valve closure element configured as a disk has less kinetic energy than a comparable ball. Additionally, a mass of the valve closure element can be reduced by using ceramic as a material. Furthermore, the check valve can be arranged in the connecting rod so that the movement of the valve closure element is performed parallel to an effect of mass forces acting upon the connecting rod. Thus, a movement of the valve closure element can be advantageously supported by the mass forces.

Flow channels that are difficult to manufacture like, e.g., radial grooves, can be omitted due to the geometry of the valve closure element that is configured as a plate. Thus, it is possible to achieve a more cost-effective configuration of the check valve.

The check valve according to the invention is configured in particular for an application at a hydraulic chamber which is configured as a support chamber of an eccentrical element adjustment arrangement of a connecting rod for a variable compression internal combustion engine.

According to an advantageous embodiment the valve closure element can be provided axially movable along a longitudinal valve axis between an open position and a closed position and the disk can have a pin-shaped protrusion in the axial direction. This way the check valve can perform its closing function reliably since the disk-shaped valve closure element can open and close a radial circumferential opening between the disk and the valve seat evenly by the axial movement. Through the pin-shaped protrusion at the disk in the axial direction the valve closure element itself can be reliably supported during its axial movement. Furthermore, also the valve spring can be reliably supported by the pin-shaped protrusion so that the function of the valve closure element can also be performed reliably under external vibrations and pressure spikes in the hydraulic supply.

According to an advantageous embodiment the valve closure element can be supported in the valve housing by a support element. Thus, the support element which can envelope, e.g., the pin-shaped protrusion of the valve closure element facilitates a reliable support of the valve closure element in the longitudinal direction of the check valve. The support element can thus be configured as an axial support in the valve housing itself. Alternatively thereto, however, it is also possible to arrange the support element as an additional component in the valve housing, e.g. to press it into the valve housing. Thus, the pin-shaped protrusion of the valve closure element can be reliably retained and supported during an axial movement of the valve closure element. Also this way a modular assembly of the check valve can be advantageously provided.

According to an advantageous embodiment the support element can radially envelope the pin-shaped protrusion of the valve closure element. The support element, which can, e.g., envelope the pin-shaped protrusion of the valve closure element facilitates a reliable support of the valve closure element in the longitudinal direction of the check valve. Thus, a sliding support of the pin-shaped protrusion of the valve closure element can be provided since the support by the support element is flowed through by the hydraulic fluid during operations so that a low wear movement of the valve closure element is assured.

According to an advantageous embodiment the valve closure element can be preloaded against a valve seat by a valve spring. The valve spring facilitates pressing the valve closure element in a no-pressure condition against the valve seat which blocks the check valve. A suitable selection of a strength of the valve spring facilitates adjusting the opening function of the check valve to a predetermined hydraulic fluid pressure. Thus, the check valve with the valve spring is adaptable to different applications. Furthermore, the check valve can be fabricated in a flexible manner by selecting different valve springs.

According to an advantageous embodiment the valve spring can envelope the pin-shaped protrusion radially and can be arranged preloaded between a contact sleeve that envelopes the pin-shaped protrusion at least partially and the support element. This way it is advantageously possible to reliably support the valve spring at the pin-shaped protrusion since the valve spring receives the pin-shaped protrusion in its interior.

On the other hand side, the valve spring can be supported at one end at the contact sleeve which can envelop the pin-shaped protrusion at least partially and can be connected therewith so that the valve spring is supported at the valve closure element at the one end of the valve spring and so that the valve spring is supported at the other end at the support element which is connected with the valve element. Thus, a reliable preload of the valve closure element relative to the valve housing is provided.

According to an advantageous embodiment, the valve spring can be supported along its length by the contact sleeve. The contact sleeve which is connected with the pin-shaped protrusion of the valve closure element can thus radially envelope the pin-shaped protrusion. Thus, the valve spring which also envelopes the pin-shaped protrusion can also envelope the contact sleeve. Thus, the valve spring is support by the contact sleeve which runs in an interior of the valve spring which assures a reliable function of the check valve.

According to an advantageous embodiment the contact sleeve can axially receive the pin-shaped protrusion in an interior portion of the contact sleeve. Thus, the contact sleeve can envelop the pin-shaped protrusion in order to provide a safe connection with the valve closure element and can in particular receive the pin-shaped protrusion in its interior over its entire length. Thus, a safe connection is provided between the contact sleeve and the pin-shaped protrusion, in particular the contact sleeve can be pressed onto the pin-shaped protrusion. Thus, the valve spring can be reliably supported by the contact sleeve.

According to an advantageous embodiment the contact sleeve can be at least partially arranged in an interior of the valve spring. This way the valve spring can be supported by the contact sleeve at least along part of its length which provides a reliable function of the valve closure element, in particular a reliable axial support of the valve spring in the longitudinal direction of the check valve. Thus, an axial support of the valve spring at the contact sleeve can be advantageously provided since the valve spring is supported at the contact sleeve also in a radial direction.

According to an advantageous embodiment the support element can penetrate into the contact sleeve at least partially. This arrangement and configuration of the support element advantageously facilitates a radial support of the pin-shaped protrusion and thus of the valve closure element since the support element can envelope a large portion of a length of the pin-shaped protrusion in this manner. Thus the contact sleeve can also be supported by the support element itself which significantly improves reliability of the axial movement of the valve closure element.

According to an advantageous embodiment the valve housing can include a bolting flange at an end of the valve housing that is arranged opposite to the valve seat wherein a valve inlet is arranged at the bolting flange. Thus, a seal seat can be advantageously provided at a bore hole base for the check valve. Thus, the optional valve inlet can be configured specific, whereas the valve housing with the valve closure element has a standard configuration. This way it is possible to implement a modular design of check valves.

According to an advantageous embodiment the valve housing can have an impression flange with a seal seat at an end that is arranged opposite to the valve seat. Through the impression flange with the seal seat the check valve can be pressed directly into the connecting rod. Thus, no additional bore hole for the check valve has to be provided in the connecting rod which is advantageous. The pressed interconnection of check valve and connecting rod provides a safe valve function with a reliable sealing of the check valve in the connecting rod.

According to an advantageous embodiment an interior portion of the valve housing and/or the support element can have at least one opening in the axial direction in order to achieve a flow through of hydraulic fluid when opening the valve closure element. The flow through of the interior portion of the check valve with hydraulic fluid can be provided through the openings in the valve housing itself and/or in the support element, e.g., by additional bore holes. This way a fluid path can be provided along the pin-shaped protrusion and/or along the contact sleeve through the support element and/or the inner portion of the valve housing to the valve seat and from there into a hydraulic chamber of the connecting rod when the valve closure element is open.

According to an advantageous embodiment the valve housing and the support element can be integrally configured in one piece. This type of design provides a firm connection of the valve housing and the support element so that a support function of the support element for the pin shaped protrusion and thus for the valve closure element is provided in an advantageous manner. A joint fabrication of the valve housing and the support element reduces production costs for the check valve since mounting the check valve is simplified.

According to another aspect of the invention, a connecting rod for a variable compression internal combustion engine is provided. The connecting rod comprising at least one hydraulic chamber which is connectable by a check valve with a bearing shell or a tank. The connecting rod can include, e.g., an eccentrical element adjustment arrangement for adjusting an effective connecting rod length, wherein the eccentrical element adjustment arrangement includes an eccentrical element which cooperates with an eccentrical element lever and two pistons which are respectively movably supported in a hydraulic chamber and in which eccentrical element rods of the eccentrical element adjustment arrangement are supported that engage the eccentrical element lever. An adjustment travel of the eccentrical element adjustment arrangement can be adjustable by a switch valve. Changing the adjustment travel adjusts an effective connecting rod length. Thus, a compression of an internal combustion engine can be controlled. Check valves in the connecting rod can respectively prevent a flow back of hydraulic fluid from the at least one hydraulic chamber into the bearing shell or into a tank.

### BRIEF DESCRIPTION OF THE DRAWINGS

Further advantages can be derived from the subsequent drawing description. The drawing illustrates an embodiment of the invention. The drawings, the description and the claims include several features in combination. A person skilled in the art will advantageously view the features also individually and will combine them into additional useful combinations, wherein

FIG. 1 illustrates a schematic view of a connecting rod according to the invention;

FIG. 2 illustrates a blown up view of the connecting rod according to FIG. 1;

FIG. 3 illustrates a longitudinal sectional view of a check valve according to an embodiment of the invention in a closed position;

FIG. 4 illustrates a partial sectional isometric view of a check valve according to FIG. 3 in a closed position;

FIG. 5 illustrates a longitudinal sectional view of a check valve according to another embodiment of the invention in a closed position;

FIG. 6 illustrates a partial sectional isometric view of a check valve according to FIG. 5 in a closed position;

FIG. 7 illustrates a longitudinal sectional view of a check valve according to FIG. 3 in an open position;

FIG. 8 illustrates a partial sectional isometric view of a check valve according to FIG. 3 in a closed position;

FIG. 9 illustrates a longitudinal sectional view of the check valve according to FIG. 5 in an open position;

FIG. 10 illustrates a partial sectional isometric view of a check valve according to FIG. 5 in an open position;

FIG. 11 illustrates a longitudinal sectional view of a check valve according to another embodiment of the invention in a closed position;

FIG. 12 illustrates a partial sectional isometric view of the check valve according to FIG. 11 in a closed position;

FIG. 13 illustrates a longitudinal sectional view of the check valve according to FIG. 11 in an open position;

FIG. 14 illustrates a partial section isometric view of a check valve according FIG. 11 in an open position.

### DETAILED DESCRIPTION OF THE INVENTION

In the drawing figures identical or like components are designed with identical reference numerals. The drawing figures merely illustrate embodiments and do not limit the spirit and scope of the invention.

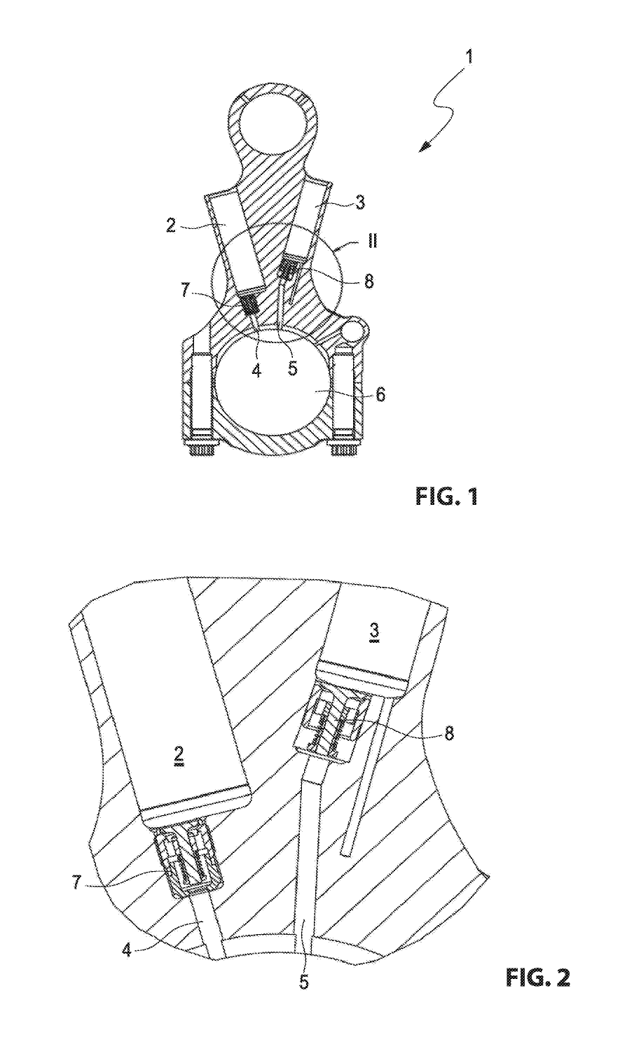

FIG. 1 schematically illustrates a connecting rod 1 according to the invention for a variable compression internal combustion engine with a non-illustrated eccentrical element adjustment arrangement for adjusting an effective connecting rod length. The eccentrical element adjustment arrangement includes an eccentrical element that cooperates with an eccentrical element lever. Thus, an adjustment travel of the eccentrical element adjustment arrangement is adjustable by a non-illustrated switch valve.

A rotation of the adjustable eccentrical element adjustment arrangement is initiated by an impact of mass and load forces of the internal combustion engine which impact the eccentrical element adjustment arrangement during an operating stroke of the internal combustion engine. Effective directions of forces impacting the eccentrical element adjustment arrangement change continuously during an operating stroke. The rotating movement or adjustment movement is supported by a piston that is loaded with hydraulic fluid, in particular motor oil and integrated in the connecting rod 1, or the pistons prevent a resetting of the eccentrical element adjustment arrangement due to varying force effective directions of forces impacting the eccentrical element adjustment arrangement.

The pistons are operatively connected by eccentrical element rods on both sides with an eccentrical element of the eccentrical element adjustment arrangement. The pistons are movably arranged in hydraulic chambers 2, 3 and loaded through hydraulic fluid conduits 4, 5 from the crank bearing eye 6 with hydraulic fluid through check valves 7, 8 which are visible in particular in a blown up detail of the connecting rod 1 that is illustrated in FIG. 2. The check valves prevent a flow back of the hydraulic fluid from the hydraulic chambers 2, 3 into the hydraulic fluid conduits 4, 5 and from there into a bearing shell of the crank bearing eye 6 or a tank and in turn facilitate a pulling of hydraulic fluid into the hydraulic chambers 2, 3. The hydraulic chambers 2, 3 are connected with additional non-illustrated hydraulic fluid conduits which cooperate with the switch valve.

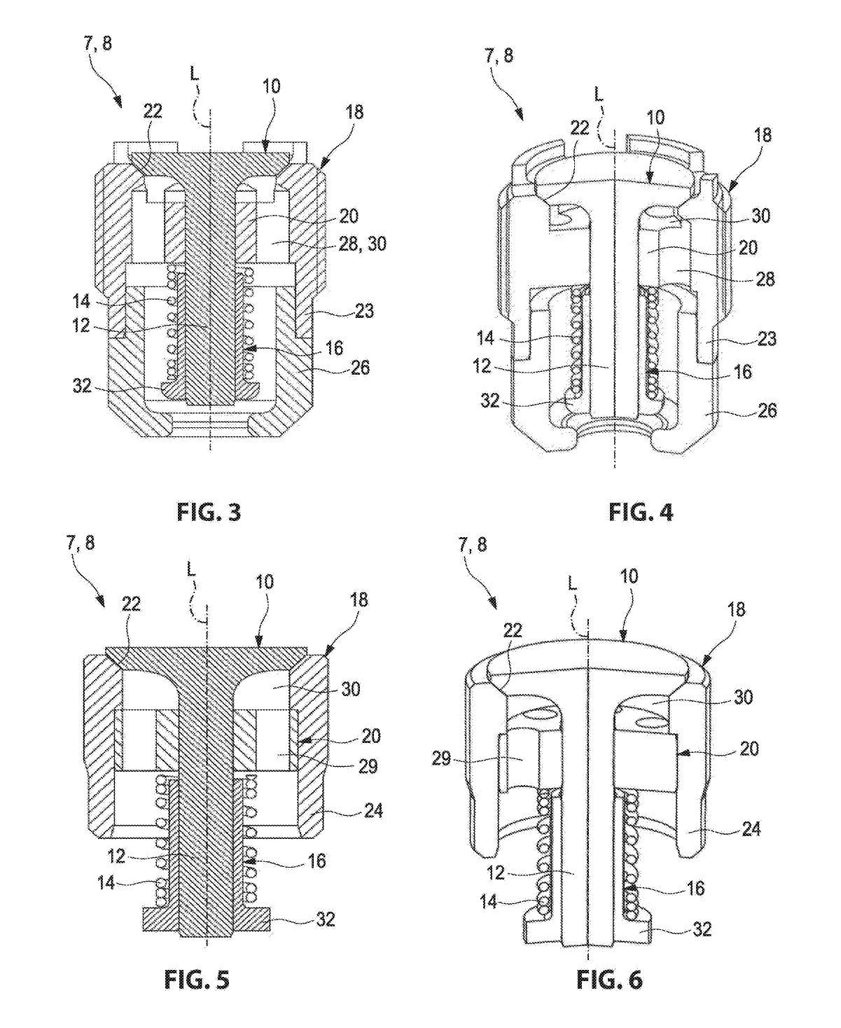

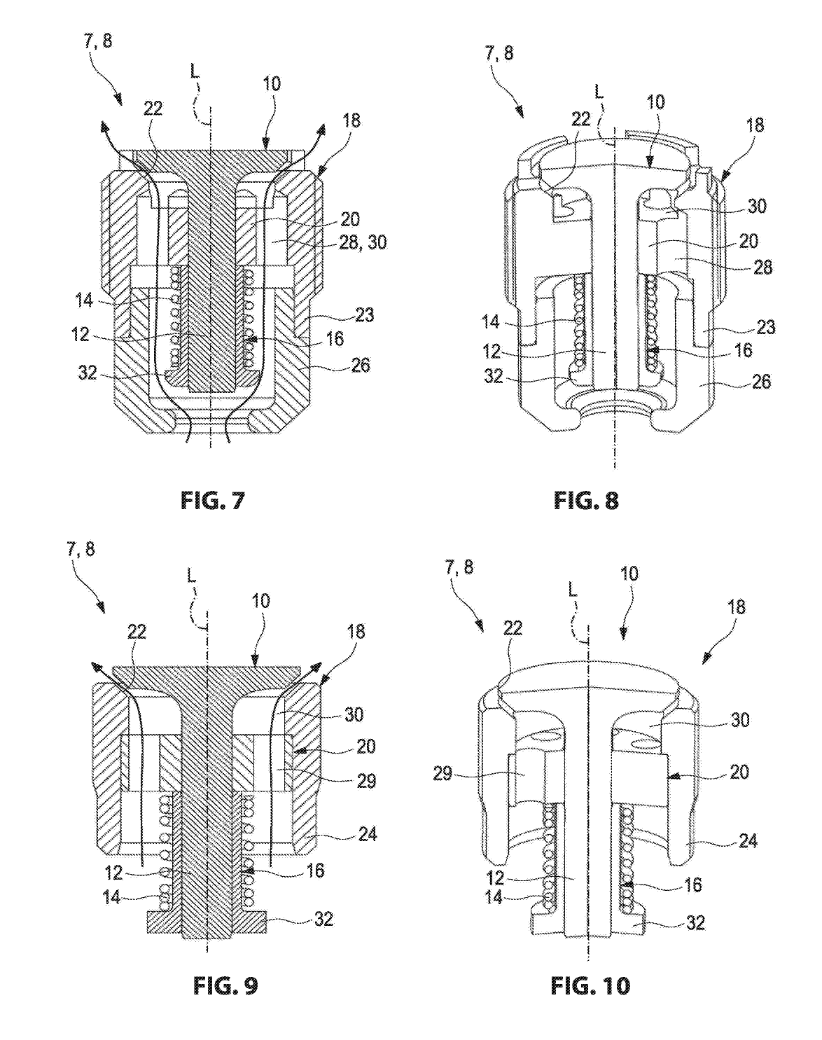

Two embodiments of a check valve 7, 8 according to the invention can be derived from FIGS. 3-10. Thus, FIGS. 3 and 4 illustrate the first embodiment in a closed position of the check valve 7, 8 and FIGS. 7 and 8 illustrate the check valve 7, 8 in an open position. Accordingly FIGS. 5 and 6 illustrate the second embodiment in a closed position of the check valve 7, 8 and FIGS. 9 and 10 illustrate the second embodiment in the open position of the check valve 7, 8.

In the check valves 7, 8 according to the invention the valve closure element 10 is configured as a disc and axially movable along a longitudinal valve axis L between an open position and a closed position. Through a pin shaped protrusion 12 which is arranged in the axial direction L at the valve closure element 10 the vale closure element 10 can be supported in a support element 20 in the valve housing 18. The support element 20 thus envelops the pin shaped protrusion 12 of the valve closure element 10 radially.

The valve closure element 10 is preloaded by a valve spring 14 against a valve seat 22. The valve spring 14 envelops the pin shaped protrusion 12 radially and is arranged preloaded between a contact sleeve 16 that envelops the pin shaped protrusion 12 at least partially and the support element 20. Thus, the valve spring 14 contacts a shoulder 32 of the contact sleeve 16. The valve spring 14 is supported over its entire length by the contact sleeve 16. Thus, the contact sleeve 16 is at least partially arranged in an interior of the valve spring 14.

The contact sleeve 16 receives the pin shaped protrusion 12 axially in its interior portion and is connected with the pin shaped protrusion in particular in the portion of the shoulder 32.

The valve closure element 10 is advantageously arranged in the flow direction of the hydraulic fluid downstream of the valve spring 14 so that the valve spring 14 is permanently arranged in the low pressure portion. The valve closure element 10 configured as a disc has a larger surface area compared to a sphere so that higher forces are generated for the same pressure. Thus, more robust and stronger valve springs 14 can be used and the system becomes stiffer. For the same flow cross section the valve closure element 10 (disc) has to travel less than a ball.

The valve closure element 18 and the support element 20 are configured integral in one piece in the embodiment illustrated in FIGS. 3 and 4 and 7 and 8, this means the support element 20 is part of the valve housing 18. Thus, the valve housing 18 includes axially oriented openings 28 in an interior portion 30 and thus also the support element 20 includes the axially oriented openings 28 in order to facilitate a flow through of hydraulic fluid when opening the valve closure element 10.

The valve housing 18 has a threading flange 23 at an end that is arranged opposite to the valve seat 22 wherein a sleeve shaped valve inlet 26 is arranged at the threading flange 23. The valve inlet 26 can be provided with a sealing portion at its open end. Through the threading flange 23 the check valve 7, 8 can also be threaded tight into a threaded bore hole of a connecting rod 1.

In the embodiment illustrated in FIGS. 5 and 6 and 9 and 10 a separate support element 20 is arranged in an interior portion 30 of the valve housing 18 wherein the separate support element can be for example pressed in when mounting the check valve 7, 8. The support element 20 has openings 29 in an axial direction in order to facilitate a flow through of hydraulic fluid when opening the valve closure element 10. The valve housing 18 furthermore includes a press in flange 24 with a seal seat at an end that is opposite to the valve seat 22 so that the check valve 7, 8 can be pressed directly into a connecting rod 1 so that the check valve is sealed tight.

Compared to the known check valves overflow channels that are difficult to fabricate can be omitted in the check valve 7, 8 according to the invention. In particular the second embodiment according to FIGS. 5, 6, 9 and 10 which is pressed into the connecting rod 1 has a highly simplified and thus cost effective configuration.

Thus, the check valves 7, 8 can be arranged and positioned in the connecting rod 1 so that occurring acceleration/mass forces press the valve closure element into a valve seat 22,

In FIGS. 7-10 fluid paths are indicated by arrows for an open position of the check valves 7, 8 wherein the fluid paths and the arrows characterize a flow direction of the hydraulic fluid through the check valves 7, 8.

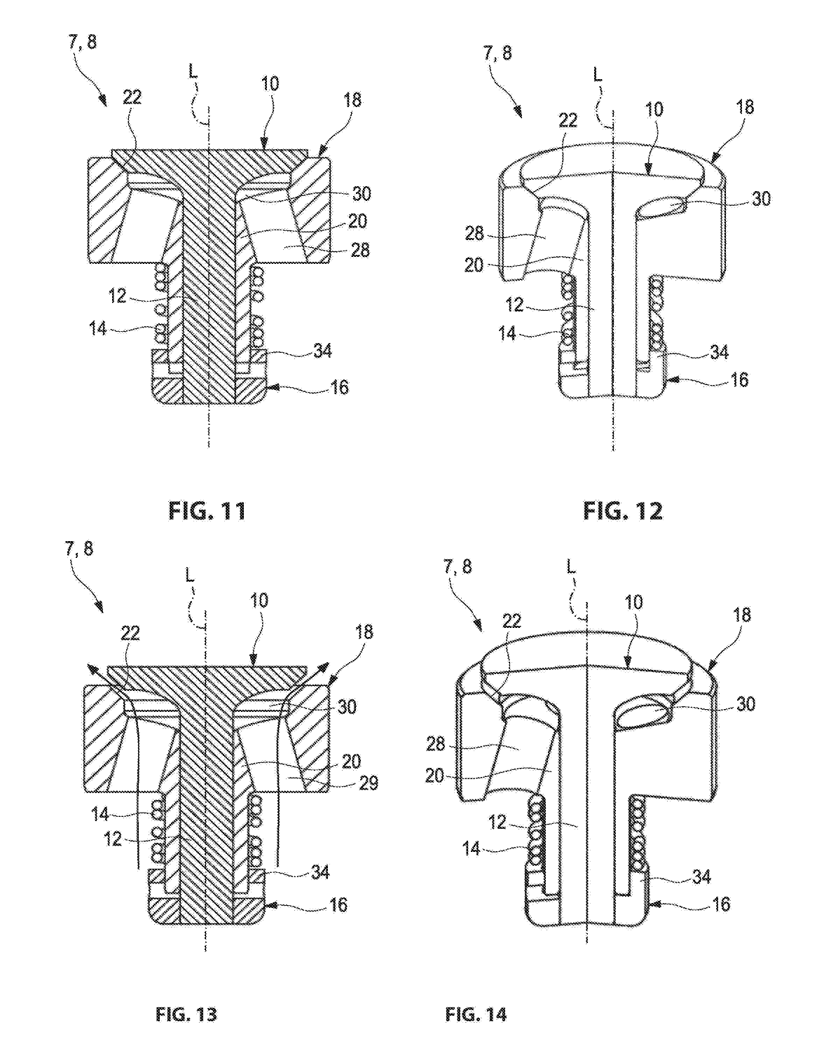

FIGS. 11-14 illustrate another embodiment of a check valve 7, 8 according to the invention. In this embodiment the valve housing 18 and the support element 20 are again configured integrally in one piece so that openings 28 are provided in the valve housing 18 so that the check valve 7, 8 is flowed through by the hydraulic fluid.

Differently from the embodiments illustrated in FIGS. 3-10 the support element 20 in this embodiment penetrates at least partially into the stop sleeve 16. The stop sleeve 16 itself is thus only pushed with a shoulder 32 over the pin shaped protrusion 12, advantageously pressed on and includes another shoulder 34 that includes an axial opening into which the support element 20 can penetrate. Thus, the disc of the valve closure element 10 rests on the cone shaped valve seat 22 of the valve housing 18 when the check valve 7, 8 is closed.

The valve spring 14 is supported by the support element 20 over its entire length in this embodiment since the support element 20 covers and entire length of the valve spring 14 in whose inner portion the support element 20 is at least partially arranged.

As evident in the open position of the check valve 7, 8 in FIGS. 13 and 14 the support element 20 penetrates further into the contact sleeve 16 when opening the check valve 7, 8 and moving the valve closure element 10 in the longitudinal direction L. Again the fluid path of the flowing hydraulic fluid is illustrated by arrows.

The embodiment illustrated in FIGS. 11-14 thus represents a particularly reliable variant since the valve spring 14 supported over its entire length by the support element. Also here the support of the pin shaped protrusion 12 of the valve closure element 10 is provided by the support element 20 over a rather long support path so that the check valve 7, 8 represents a rather robust variant of a check valve 7, 8. Furthermore configuring the check valve 7, 8 integrally in one piece provides a configuration that is compact and requires little installation space and which can be fabricated in an economical manner.

What is claimed is:

1. A check valve for a connecting rod with at least one hydraulic chamber for a variable compression internal combustion engine,
wherein the hydraulic chamber is connectable by the check valve with a hydraulic fluid conduit, and
wherein the check valve includes a valve closure element that is configured as a disc.

2. The check valve according to claim 1,
wherein the valve closure element is provided axially movable along a longitudinal valve axis between an open position and a closed position, and
wherein the disc includes a pin shaped protrusion oriented in a direction of the longitudinal valve axis.

3. The check valve according to claim 1, wherein the valve closure element is supported in a valve housing by a support element.

4. The check valve according to claim 3, wherein the support element envelops the pin shaped protrusion of the valve closure element in a radial direction.

5. The check valve according to claim 1, wherein the valve closure element is preloaded against a valve seat by a valve spring.

6. The check valve according to claim 5, wherein the valve spring radially envelops the pin shaped protrusion and is arranged with a preload between a contact sleeve that envelops the pin shaped protrusion at least partially and the support element.

7. The check valve according to claim 6, wherein the valve spring is supported by the contact sleeve over an entire length of the valve spring.

8. The check valve according to claim 6, wherein the contact sleeve receives the pin shaped protrusion axially in an interior portion of the contact sleeve.

9. The check valve according to claim 6, characterized in that the contact sleeve is at least partially arranged in an interior of the valve spring.

10. The check valve according to claim 6, wherein the support element penetrates at least partially into the contact sleeve.

11. The check valve according to claim 1,
wherein the valve housing includes a thread on flange at an end of the valve housing that is arranged opposite to the valve seat, and
wherein a valve inlet is arranged at the thread on flange.

12. A check valve according to claim 1, wherein the valve housing includes a press in flange with a seal seat at an end of the valve housing that is arranged opposite to the valve seat.

13. The check valve according to claim 3, wherein an interior portion of the valve housing or the support element includes at least one opening in an axial direction which facilitates a flow through of hydraulic fluid when the valve closure element is in an open position.

14. The check valve according to claim 3, wherein the valve housing and the support element are integrally configured in one piece.

15. A connecting rod for a variable compression internal combustion engine, the connecting rod comprising:
at least one hydraulic chamber that is connectable by the check valve according to claim 1 with a bearing shell or a tank.
